(19) United States
(12) Patent Application Publication
(10) Pub. No.: US 2011/0249292 A1
(43) Pub. Date: Oct. 13, 2011

(54) CONTROL DEVICE CAPABLE OF REDUCING POWER CONSUMPTION AND NOISE

(75) Inventor: Yasuhiko HIRANO, Yokohama-shi (JP)

(73) Assignee: CANON KABUSHIKI KAISHA, Tokyo (JP)

(21) Appl. No.: 13/079,358

(22) Filed: Apr. 4, 2011

(30) Foreign Application Priority Data
Apr. 8, 2010 (JP) 2010-089411
Mar. 23, 2011 (JP) 2011-064830

(51) Int. Cl. G06K 15/02

(52) U.S. Cl. 358/1.15

(57) ABSTRACT

A control device that is capable of reducing power consumption and noise generation. The control device controls output of a clock signal to a data processing circuit that executes data processing in synchronism with the input clock signal. A switching section for switching the image output clock signal between a high-frequency clock signal and a low-frequency clock signal is controlled to output the high-frequency clock signal for data processing when the data processing is executed by the data processing circuit, and output the low-frequency clock signal when the data processing is not executed by the data processing circuit.

### BACKGROUND OF THE INVENTION

1. Field of the Invention

The present invention relates to a control device for a data processing circuit.

2. Description of the Related Art

Conventionally, as a printer that prints image data, there has been proposed a printer that converts the image data to multi-valued image data by pattern conversion using a table, and then performs parallel-serial conversion of the multi-valued image data to output the resulting image data to a printer engine (see e.g. Japanese Patent Laid-Open Publication No. 2003-54032).

To output image data to the printer engine after performing parallel-serial conversion thereof, it is required to control driving of a data processing circuit by a high-frequency image output clock obtained by multiplication (integral multiplication) of the frequency of an original clock for image output (hereafter referred to as the“image output original clock”).

Further, with a view to increasing the printing speed thereof, if the printer has the frequency of the image output clock increased to several hundreds MHz by multiplying (integrally multiplying) the frequency of the image output original clock, this causes not only unnecessarily increased power consumption when the printer is not printing and hence the high-frequency image output clock is not required, but also increased noise generation.

To solve this problem, it is envisaged to configure a PLL (phase locked loop), which multiplies (integrally multiplies) the frequency of the image output original clock to output the image output clock, such that the PLL is once caused to stop the output of the image output clock, and after the setting of the frequency is changed, the PLL is caused to resume the output of the image output clock.

In this case, for example, as shown in FIG. 9, a controller interrupts the input of the clock to the PLL in response to a sheet leading edge detection signal to thereby once cause the PLL to stop outputting the clock. Next, the controller reconfigures the PLL such that the frequency of the clock is increased, and then resumes the input of the clock to the PLL. After the lapse of a lockup time of hundreds μ sec, the PLL resumes the output of the clock with an increased frequency to which it is set.

In the above-described control of stopping and resuming the operation of the PLL, it is necessary to cause the printer to be on standby for execution of image output before the lockup time elapses, which causes a time loss.

### SUMMARY OF THE INVENTION

The present invention provides a control device configured to reduce power consumption and noise generation, and make it possible to reduce a time loss due to lockup time caused when clock output for driving a data processing circuit is interrupted and resumed.

The present invention provides a control device that controls output of a clock signal to a data processing circuit that executes data processing in synchronism with the input clock signal, comprising a first clock output unit configured to output a first clock signal for the data processing, a second clock output unit configured to output a second clock signal of which frequency is lower than that of the first clock signal for the data processing, a switching unit configured to switch the clock signal between the first clock signal for the data processing output from the first clock output unit and the second clock signal output from the second clock output unit and output the clock signal to the data processing circuit, and a control unit configured to cause the switching unit to output the first clock signal for the data processing when the data processing is executed by the data processing circuit, and cause the switching unit to output the second clock signal when the data processing is not executed by the data processing circuit.

According to the present invention, it is possible to obtain an advantageous effect that it is possible to reduce power consumption and noise except when data processing is performed. Further, according to the present invention, it is possible to obtain an advantageous effect that it is possible to reduce the time loss by making it unnecessary to await the elapse of the lockup time of a PLL during data processing.

Further features of the present invention will become apparent from the following description of exemplary embodiments with reference to the attached drawings.

### BRIEF DESCRIPTION OF THE DRAWINGS

FIG. 1 is a block diagram of the hardware configuration of an image forming apparatus including a control device according to a first embodiment of the present invention.

FIG. 2 is a functional block diagram of a printer interface appearing in FIG. 1.

FIG. 3 is a flowchart of a clock frequency-setting process executed by the image forming apparatus.

FIG. 4 is a diagram illustrating a relationship between conveyance of a sheet and an image output clock in the image forming apparatus.

FIG. 5 is a block diagram of the internal hardware configuration of a printer interface of an image forming apparatus including a control device according to second and third embodiments of the present invention.

FIG. 6 is a diagram illustrating a relationship between conveyance of a sheet and an image output clock in the image forming apparatus including the control device according to the second embodiment.

FIG. 7 is a flowchart of a clock frequency-setting process executed by the image forming apparatus including the control device according to the third embodiment.

FIG. 8 is a diagram illustrating a relationship between conveyance of a sheet and an image output clock in the image forming apparatus including the control device according to the third embodiment.

FIG. 9 is a diagram illustrating an operation performed by a conventional image forming apparatus when the output of an image output original clock is once interrupted and is resumed after the frequency is changed.

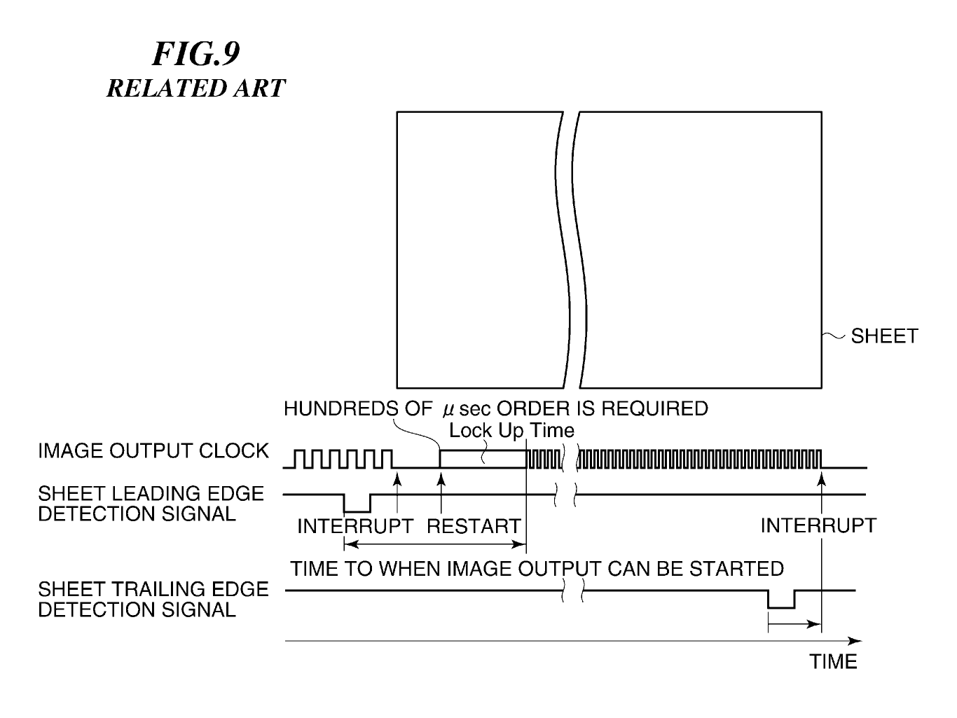

### DETAILED DESCRIPTION OF THE EMBODIMENTS

The present invention will now be described in detail below with reference to the accompanying drawings showing embodiments thereof.

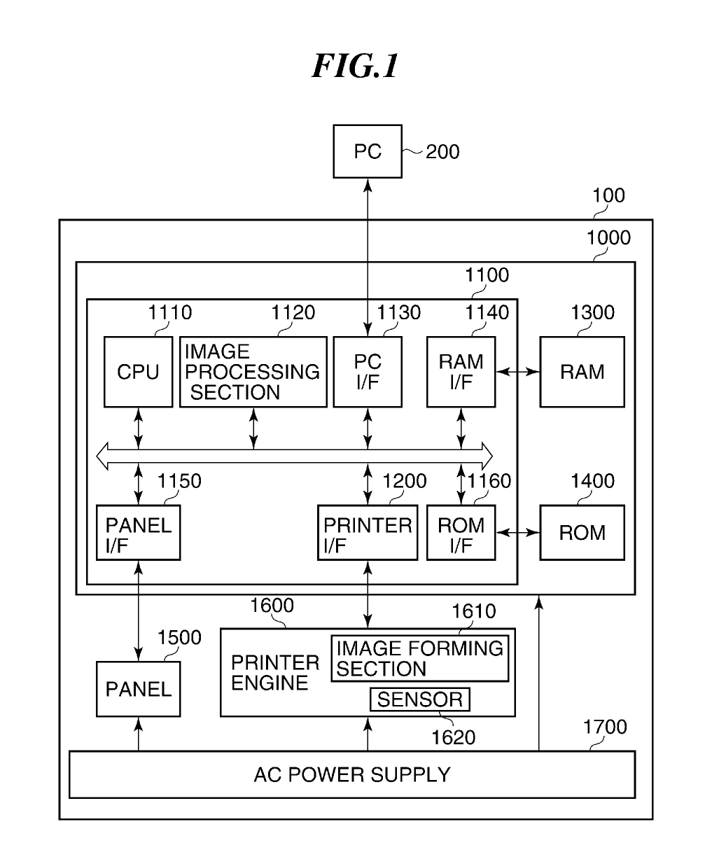

A description will be given of the hardware configuration of an image forming apparatus including a control device according to a first embodiment of the present invention with reference to FIG. 1.

In FIG. 1, reference numeral 100 denotes an image forming apparatus, and reference numeral 200 denotes a PC which is connected to the image forming apparatus 100 via a PC interface, such as a network or a USB (universal serial bus).

This image forming apparatus 100 includes a controller 1000 for controlling the overall operation of the image forming apparatus. Further, the controller 1000 includes an ASIC (application-specific integrated circuit) 1100.

The ASIC 1100 includes a CPU 1110 as a control section that controls various sections of the controller 1000, and an image processing section 1120 that performs image processing on a print job sent from the PC 200.

The ASIC 1100 further includes a PC interface 1130 that receives a print job sent from the PC 200, and a RAM interface 1140 that performs data communication with a RAM 1300. The ASIC 1100 includes not only these interfaces but also a panel interface 1150 that performs communication with a panel 1500 as a user interface, and a ROM interface 1160 that performs communication with a ROM 1400. The ASIC 1100 further includes a printer interface 1200 that transfers image data to a printer engine 1600 and controls communication therewith.

Further, the controller 1000 includes the RAM 1300 that provides areas for executing control programs, storing work data for image processing, and storing image data, and the ROM 1400 that stores the control programs.

Further, the image forming apparatus 100 includes the panel 1500 as a user interface, and the printer engine 1600 that performs printing. The printer engine 1600 includes an image forming section 1610 that forms an image on a sheet, and a sensor 1620 disposed on a conveying path for conveying the sheet into the image forming section 1610 at a location upstream of the image forming section 1610 in a sheet conveying direction, for detecting a leading edge and a trailing edge of the sheet. The image forming apparatus 100 includes an AC power supply 1700 that supplies electric power to the controller 1000, as well.

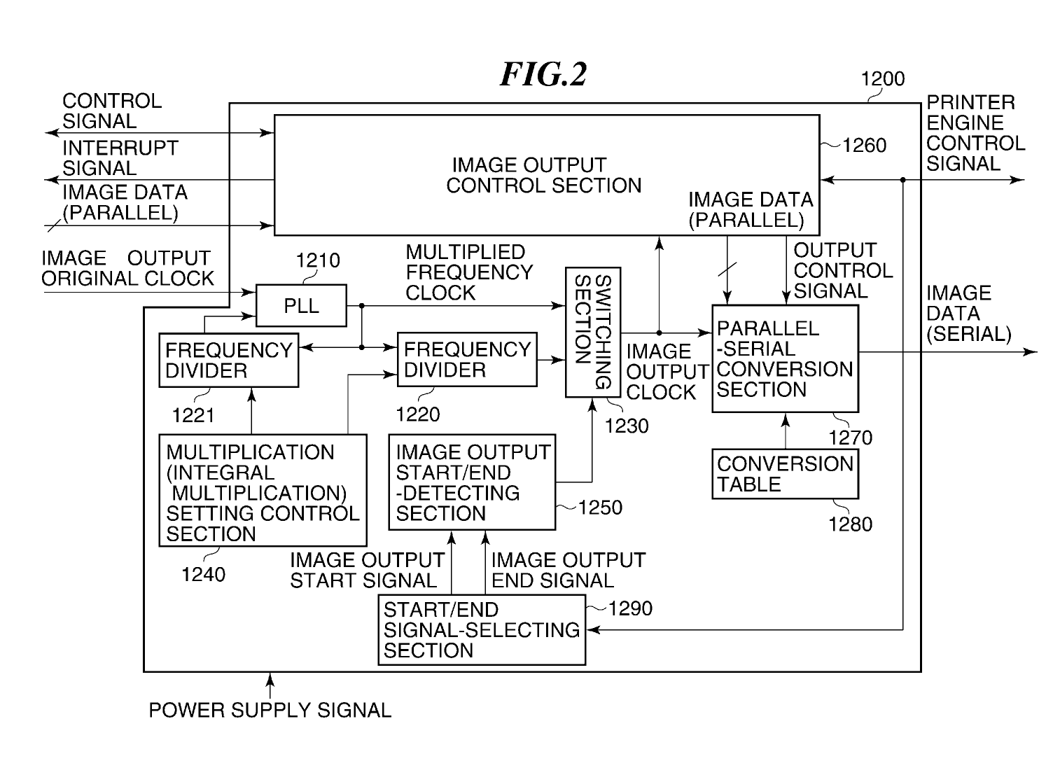

Next, a description will be given of the internal hardware configuration of the printer interface 1200 with reference to FIG. 2.

In FIG. 2, reference numeral 1210 denotes a PLL (first clock output unit) that generates a high-frequency clock (high-frequency clock signal) as a clock signal for data processing by multiplying (integrally multiplying) the frequency of an image output original clock. It should be noted that the PLL 1210 (first clock output unit) outputs a first clock signal for data processing.

In FIG. 2, reference numeral 1220 denotes a frequency divider (second clock output unit) that divides the frequency of the high-frequency clock output from the PLL 1210 according to a setting, to thereby generate a low-frequency clock (low-frequency clock signal) as a clock signal for standby. It should be noted that the frequency divider 1220 (second clock output unit) outputs a second clock signal of which the frequency is lower than that of the first clock signal for data processing. Reference numeral 1221 denotes a frequency divider that is used to multiply (integrally multiply) the frequency of the image output original clock.

The above-mentioned frequency multiplied (integrally multiplied) by the PLL 1210 and the frequency generated by the frequency divider 1220 are set and controlled by a multiplication (integral multiplication) setting control section 1240. The multiplication (integral multiplication) setting control section 1240 controls the frequency divider 1221 such that the multiplied (integrally multiplied) frequency clock is output by the PLL 1210.

Further, a switching section 1230 switches between the high-frequency clock output from the PLL 1210 and the low-frequency clock output from the frequency divider 1220 whereby the selected one of them is output as an image output clock. That is, the switching section 1230 switches the image output clock between the high-frequency clock which is the clock signal for data processing and the low-frequency clock which is the clock signal for standby, and thereby outputs the image output clock without interruption.

The switching between the high-frequency clock and the low-frequency clock by the switching section 1230 is executed in response to a signal indicative of timing of the start or end of the image output, which is received from an image output start/end-detecting section 1250. The switching section 1230 switches to output the clock signal for data processing during execution of data processing by an image output control section 1260 and a parallel-serial conversion section 1270, and switches to output the clock signal for standby during a standby state of these sections.

The image output start/end-detecting section 1250 receives an image output start signal or an image output end signal selected by a start/end signal-selecting section 1290 to thereby detect the timing of start or end of the image output.

The image output control section 1260 is a data processing circuit that executes data processing in synchronism with the image output clock input thereto from the switching section 1230. The image output control section 1260 performs output control of a control signal and image data for the printer engine 1600 and the parallel-serial conversion section 1270.

Further, the parallel-serial conversion section 1270 is also a data processing circuit that executes data processing in synchronism with the image output clock input thereto from the switching section 1230. The image data and the output control signal processed by the image output control section 1260 are also input to the parallel-serial conversion section 1270.

The parallel-serial conversion section 1270 performs parallel-serial conversion on the image data using a conversion table 1280 for parallel-serial conversion.

Further, sections in FIG. 2 which necessitate electric power is each supplied with electric power via a power supply signal from the AC power supply 1700 appearing in FIG. 1.

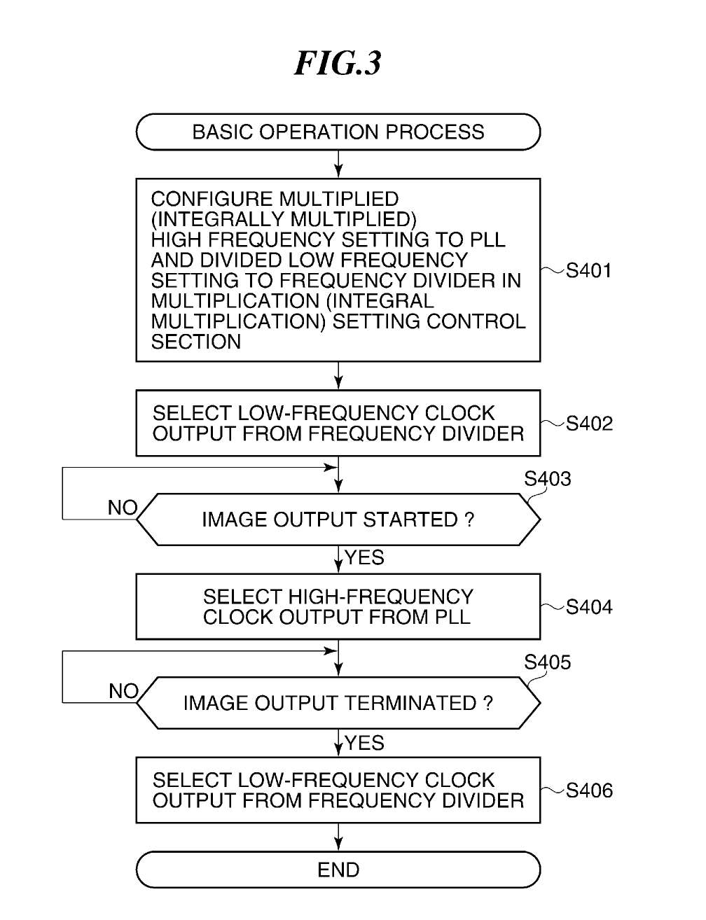

Next, a description will be given of a clock frequency-setting process executed by the above-described image forming apparatus with reference to FIG. 3.

The controller 1000 of the image forming apparatus 100 starts a basic operation process after the power is turned on to supply electric power from the AC power supply 1700. Then, the CPU 1110 configures a multiplied (integrally multiplied) high frequency setting to the PLL 1210 and a divided low frequency setting to the frequency divider 1220, in the multiplication (integral multiplication) setting control section 1240, via signals, not shown (step S401). The multiplication (integral multiplication) setting control section 1240 sets the frequency of the clock output from the PLL 1210 according to the setting for multiplied (integrally multiplied) high frequency, and sets the frequency of the clock output from the frequency divider 1220 according to the setting for divided low frequency.

Next, the switching section 1230 initially selects the low-frequency clock output from the frequency divider 1220 (step S402).

Next, the controller 1000 is on standby until a print job is received from the PC 200 via the PC interface 1130. Then, upon receipt of a print job from the PC 200, the controller 1000 starts to perform an image output operation.

Then, the image output start/end-detecting section 1250 detects the start of image output by an image output start/end-detecting operation, described hereinafter (step S403).

Next, when the image output start/end-detecting section 1250 detects the start of image output, it sends a signal indicative of the timing of start of the image output to the switching section 1230, and the switching section 1230 selects the high-frequency clock output from the PLL 1210 (step S404). In doing this, the switching section 1230 switches the image output clock during a low-level section thereof to prevent a short-period pulse from being output.

Next, the controller 1000 starts to deliver the image data to the printer engine 1600 to complete the image output operation based on the print job.

Then, the image output start/end-detecting section 1250 detects the end of image output by the image output start/end-detecting operation, described hereinafter (step S405).

Then, when the image output start/end-detecting section 1250 detects the end of image output, it sends a signal indicative of timing of the end of image output to the switching section 1230, and the switching section 1230 selects the low-frequency clock output from the frequency divider 1220 (step S406). In doing this, the switching section 1230 switches the image output clock during a low-level section thereof to prevent a short-period pulse from being output.

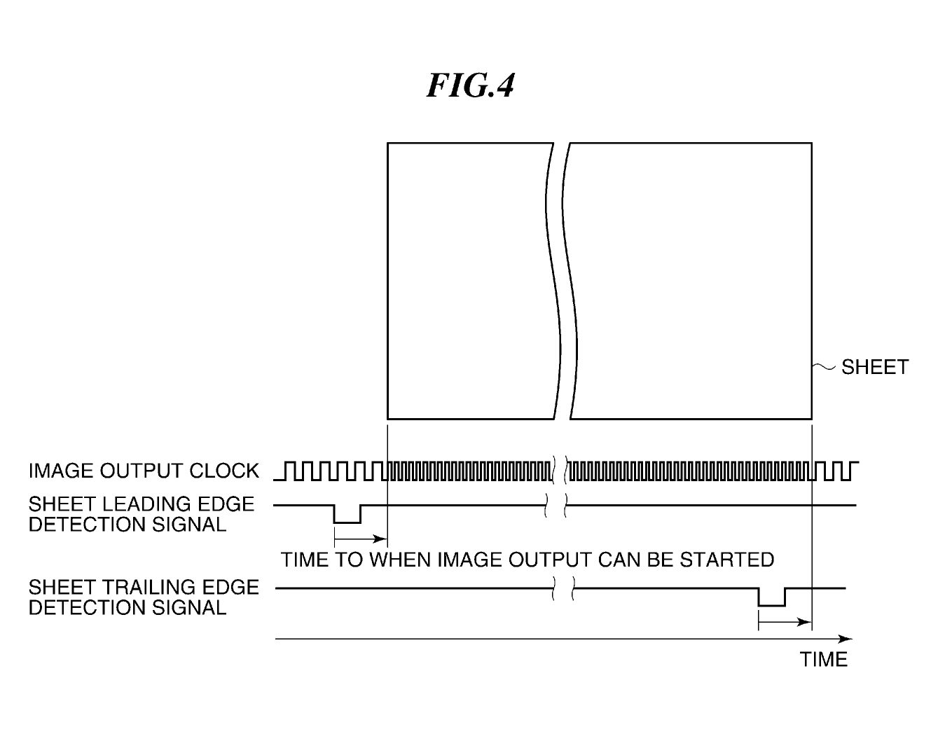

Next, a description will be given of the image output start/end-detecting operation in the steps S403 and S405 of the clock frequency-setting process in FIG. 3 with reference to FIGS. 2 and 4. It should be noted that in the first embodiment, the star and end of image output are set to respective time points when a detection signal is input which is generated when a leading edge of a sheet is detected and when a detection signal is input which is generated when the trailing edge of the sheet is detected.

After the conveyance of a sheet for image output is started, when the sensor 1620 of the printer engine 1600 detects the leading edge of the sheet being conveyed, it outputs a sheet leading edge detection signal (low active signal in FIG. 4). When the sensor 1620 further detects the trailing edge of the sheet, it outputs a sheet trailing edge detection signal (low active signal in FIG. 4).

The sheet leading edge detection signal is sent to the image output control section 1260 and the start/end signal-selecting section 1290. Then, in response to the sheet leading edge detection signal, the start/end signal-selecting section 1290 delivers the image output start signal to the image output start/end-detecting section 1250.

The image output start/end-detecting section 1250 operates depending on the position of the leading edge of the sheet being conveyed on the conveying path as the leading edge of the sheet travels from the position of the sensor 1620 to immediately before the printing position, such that the image output clock is switched to the high-frequency clock immediately before the leading edge of the sheet reaches the printing position. To this end, the image output start/end-detecting section 1250 sends a signal indicative of timing of the start of the image output to the switching section 1230 upon the lapse of a predetermined time period after receiving the image output start signal. The switching section 1230 switches the image output clock to the high-frequency clock output from the PLL 1210 in response to the received signal.

The sheet trailing edge detection signal is sent to the image output control section 1260 and the start/end signal-selecting section 1290. Then, in response to the sheet trailing edge detection signal, the start/end signal-selecting section 1290 sends the image output end signal to the image output start/end-detecting section 1250.

The image output start/end-detecting section 1250 operates depending on the position and speed of the trailing edge of the sheet as the trailing edge of the sheet travels from the position of the sensor 1620 to beyond the end of the image forming section 1610, such that the image output clock is switched to the low-frequency clock immediately after the trailing edge of the sheet is conveyed out of the image forming section 1610.

To this end, the image output start/end-detecting section 1250 sends a signal indicative of timing of the end of image output to the switching section 1230 upon the lapse of a predetermined period of time after receiving the image output end signal before the image formation processing is terminated. The switching section 1230 switches the image output clock to the low-frequency clock output from the frequency divider 1220 in response to the received signal. This causes the image forming apparatus to terminate a sequence of the image output process.

Next, a description will be given of power consumption reduction effects which can be obtained when the image forming apparatus executes the above-described image output start/end-detecting operation.

In the image forming apparatus, by the above-described operations of switching the image output clock, the multiplied (integrally multiplied) high-frequency clock is input to the image output control section 1260 and the parallel-serial conversion section 1270 only for a time period required to convey the sheet for image output.

Further, the image forming apparatus is configured such that the high-frequency clock is distributed from the PLL 1210 only up to the frequency divider 1220 and the switching section 1230 during time periods except for the time period from when the leading edge of the sheet enters the image forming section 1610 to when the trailing edge of the sheet leaves the same.

Therefore, during these time periods, only the PLL 1210, the frequency divider 1220, and the switching section 1230 operate at the high-frequency clock.

Compared with these circuits, the image output control section 1260 and the parallel-serial conversion section 1270 that are switched to operate at the low-frequency clock output from the frequency divider 1220 are by far larger in circuit size.

Power consumption and noise generation have characteristics that they are proportional to the clock frequency and the circuit size.

For this reason, when image output is not performed, the image output control section 1260 and the parallel-serial conversion section 1270 having a large circuit size operate at the low-frequency clock. Therefore, compared with a case where the image output clock is not switched to the low-frequency clock, the image forming apparatus according to the embodiment is advantageous in that the power consumption and the noise generation can be reduced.

Next, a description will be given of a second embodiment of the present invention. The second embodiment differs from the first embodiment in that when the sensor 1620 detects the leading edge and trailing edge of the sheet, the CPU 1110 controls the switching section 1230 based on an interrupt signal to thereby switch the image output clock to the high-frequency clock or the low-frequency clock.

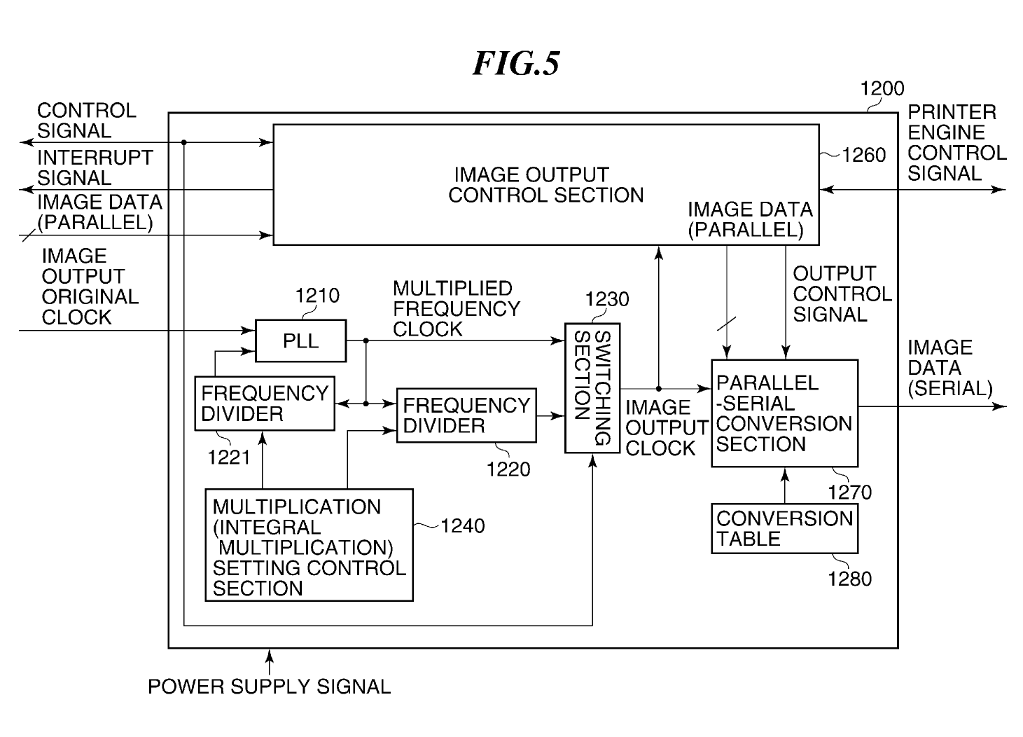

That is, in the first embodiment, the switching section 1230 is controlled by hardware based on respective detections of the leading edge and trailing edge of the sheet by the sensor 1620. On the other hand, in the second embodiment, as shown in FIG. 5, the switching section 1230 is controlled by software.

FIG. 5 illustrates the internal hardware configuration of the printer interface 1200 of the image forming apparatus including a control device according to the second embodiment. In FIG. 5, the CPU 1110 detects the start timing and end timing of image output by making use of a sheet leading edge detection interrupt signal and a sheet trailing edge detection interrupt signal, respectively, and thereby controls the switching section 1230 via a control signal.

It should be noted that in the second embodiment, a description will be mainly given of different points from the above-described first embodiment, and detailed description of the overall operation identical to that of the first embodiment is omitted.

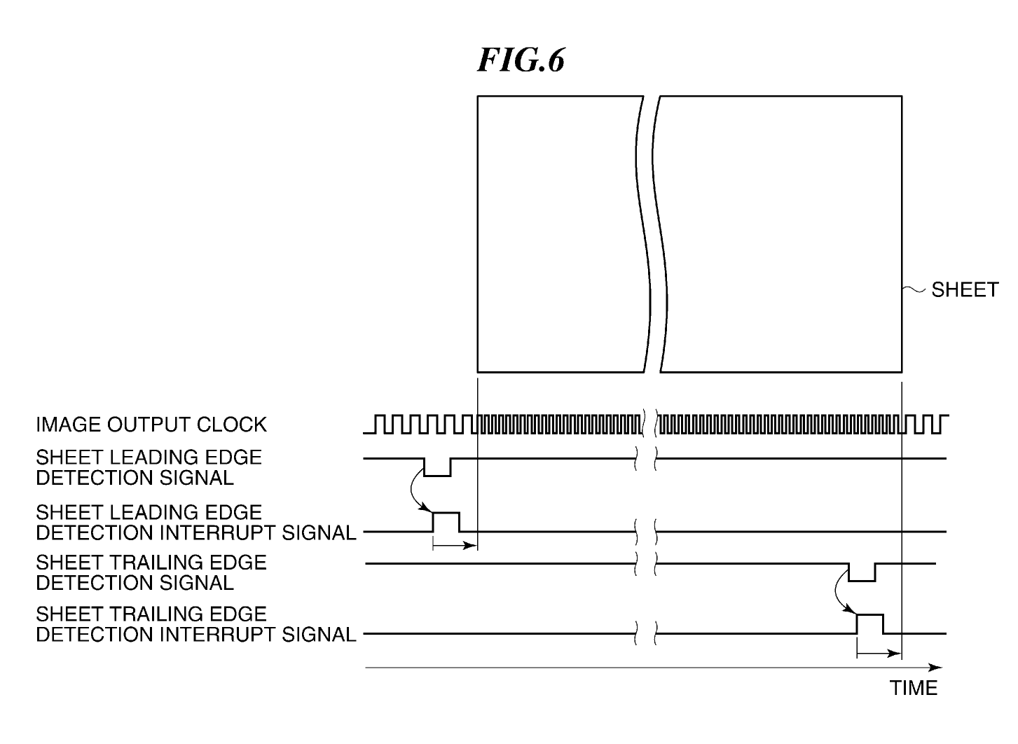

A description will be given of the image output start/end-detecting operation in the second embodiment with reference to FIGS. 5 and 6. In the second embodiment, the start and end of image output are detected by making use of the respective interrupt signals produced when the leading edge and the trailing edge of the sheet are detected.

In the image forming apparatus 100 shown in FIG. 1, when print job processing is started, a sheet starts to be conveyed toward the image forming section 1610 of the printer engine 1600. When the sensor 1620 of the printer engine 1600 detects the leading edge of the sheet being conveyed, it outputs a sheet leading edge detection signal (low active signal in FIG. 6). Further, when the sensor 1620 detects the trailing edge of the sheet, it outputs a sheet trailing edge detection signal (low active signal in FIG. 6).

The image output control section 1260 which has received the sheet leading edge detection signal sends the sheet leading edge detection interrupt signal (high active signal in FIG. 6) generated from the sheet leading edge detection signal to the CPU 1110. The CPU 1110 detects the interrupt signal as an image output start signal.

The CPU 1110 controls the switching section 1230 to switch the image output clock to the high-frequency clock output from the PLL 1210 when a predetermined time elapses after detecting the sheet leading edge detection interrupt signal. It should be noted that this predetermined time is a time period from when the CPU 1110 detects the sheet leading edge detection interrupt signal (image output start signal) output upon detection of the leading edge of the sheet by the sensor 1620 to when the leading edge of the sheet being conveyed reaches an image processing start position, which is determined based on the speed of conveying the sheet and a distance over which the sheet is to be conveyed, which are known in advance.

Further, the image output control section 1260 which has received the sheet trailing edge detection signal sends the sheet trailing edge detection interrupt signal (high active signal in FIG. 6) generated from the sheet trailing edge detection signal to the CPU 1110. The CPU 1110 detects the interrupt signal as an image output end signal.

The CPU 1110 controls the switching section 1230 to switch the image output clock from the high-frequency clock to the low-frequency clock output from the frequency divider 1220 when a predetermined time elapses after detecting the sheet trailing edge detection interrupt signal. It should be noted that this predetermined time is a time period from when the CPU 1110 detects the sheet trailing edge detection interrupt signal (image output end signal sent) sent upon detection of the trailing edge of the sheet by the sensor 1620 to when the trailing edge of the sheet being conveyed passes an image processing termination position, which is determined based on the speed of conveying the sheet and a distance over which the sheet is to be conveyed, which are known in advance.

According to the second embodiment, as shown in FIG. 5, the CPU 1110 detects image output start timing and image output end timing by making use of the sheet leading edge detection interruption signal, and executes switching control of the switching section 1230 by software. As a result, the CPU 1110 controls the switching section 1230 to activate the large-sized circuits at the high-frequency clock only during execution of image output, which makes it possible to obtain the advantageous effects that it is possible to reduce power consumption and noise generation.

Next, a description will be given of a third embodiment of the present invention. In the third embodiment, the timing of switching the image output clock is controlled by making use of an interrupt signal (signal generated when terminating image output) generated by detecting termination of outputting a valid image. It should be noted that the internal hardware configuration of the printer interface 1200 of the image forming apparatus including a control device according to the third embodiment is identical to that of the second embodiment shown in FIG. 5, and hence description thereof is omitted.

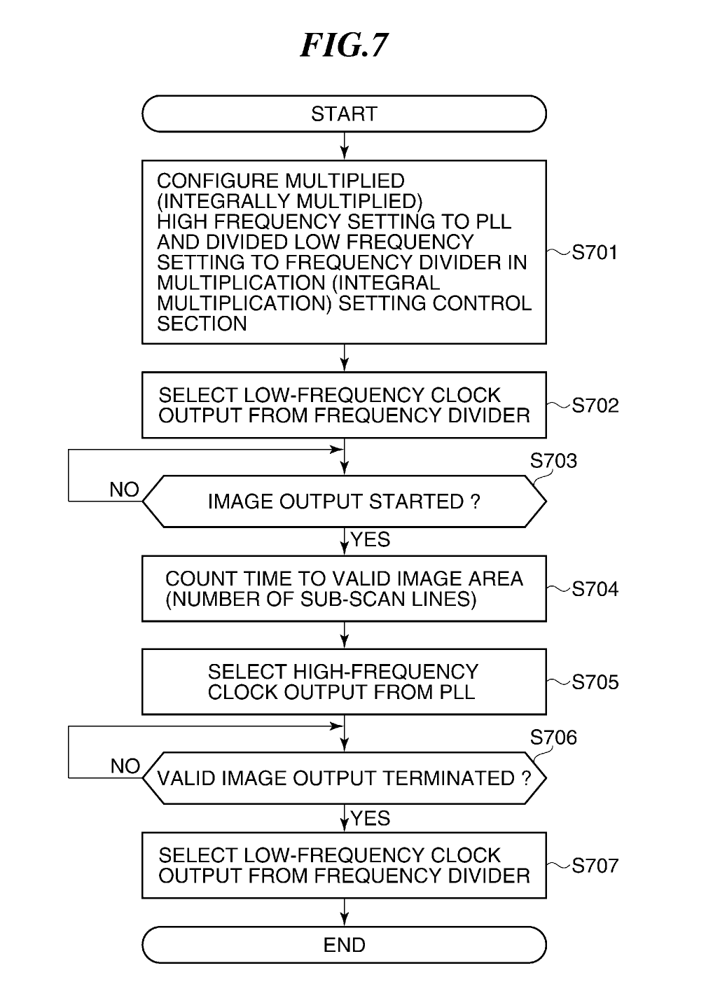

Next, a description will be given of a clock frequency-setting process executed by the image forming apparatus including the control device according to the third embodiment with reference to FIG. 7.

The controller 1000 of the image forming apparatus starts a basic operation process after electric power is supplied from the AC power supply 1700 when the power is turned on. Then, the CPU 1110 configures a multiplied (integrally multiplied) high frequency setting to the PLL 1210 and a divided low frequency setting to the frequency divider 1220, in the multiplication (integral multiplication) setting control section 1240, via signals, not shown (step S701).

Next, the CPU 1110 sets the switching section 1230 to select the low-frequency clock output from the frequency divider 1220 (step S702).

Next, the controller 1000 waits until the controller 1000 receives a print job from the PC 200 via the PC interface 1130. Then, upon receipt of the print job from the PC 200, the controller 1000 starts an image output operation. Then, the CPU 1110 detects the start of image output by an image output start/end-detecting operation, described hereinafter (step S703).

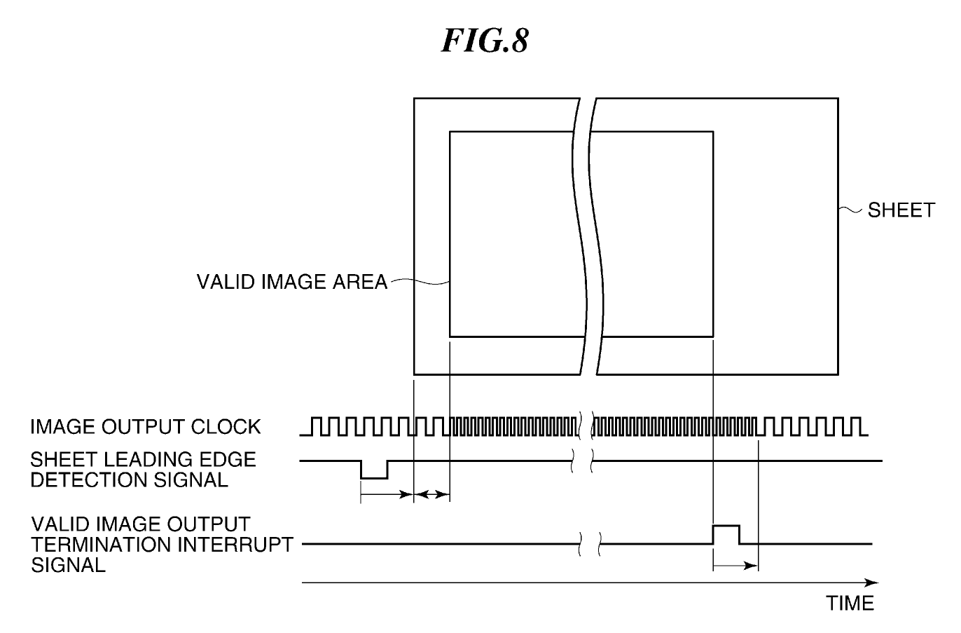

Next, the CPU 1110 which has detected the start of image output, as shown in FIG. 8, counts time before reaching a valid image area set in advance (area where images are to be formed on sheets) (step S704). This time is determined based on the number of sub-scanning lines up to the valid image area.

Next, the CPU 1110 controls the switching section 1230 to switch the image output clock to the high-frequency clock output from the PLL 1210 (step S705). In doing this, the switching section 1230 controlled by the CPU 1110 switches the clock during a low-level section thereof to prevent a short-period pulse from being output.

Next, the controller 1000 starts to output the image data to the printer engine 1600, and completes the operation of outputting a valid image based on the print job.

Then, the CPU 1110 detects the end of image output by the image output start/end-detecting operation, described hereinafter (step S706).

The CPU 1110 which has detected the end of image output controls the switching section 1230 to switch the image output clock to the low-frequency clock output from the frequency divider 1220 (step S707). In doing this, the switching section 1230 switches the image output clock during a low-level section thereof to prevent a short-period pulse from being output, and terminates the process.

Next, a description will be given of the image output start/end-detecting operation by the image forming apparatus including the control device according to the third embodiment with reference to FIGS. 5 and 8. The start and end of image output are detected by making use of a sheet leading edge detection interrupt signal and a valid image output termination interrupt signal, respectively.

The printer engine 1600 starts to convey a sheet for image formation. When the leading edge of the conveyed sheet passes the position of the sensor 1620 of the printer engine 1600, the sensor 1620 detects the leading edge of the sheet to output a sheet leading edge detection signal (low active signal in FIG. 8).

The image output control section 1260 which has received the sheet leading edge detection signal sends the sheet leading edge detection interrupt signal generated from the sheet leading edge detection signal to the CPU 1110. The CPU 1110 detects the interrupt signal as an image output start signal.

After that, the CPU 1110 controls the switching section 1230 to switch the image output clock to the high-frequency clock output from the PLL 1210 after counting the time before reaching the valid image area set in advance.

Further, when the output of the valid image set in the print job is terminated, the image output control section 1260 sends the valid image output termination interrupt signal (high active signal in FIG. 8) to the CPU 1110. The CPU 1110 detects the interrupt signal as an image output end signal.

The CPU 1110 which has received the image output end signal controls the switching section 1230 to switch the image output clock to the low-frequency clock output from the frequency divider 1220.

According to the above-described third embodiment, by setting of the time period before reaching the valid image area and detection of the valid image output termination interrupt signal, it is possible to reduce time during which the multiplied (integrally multiplied) high-frequency clock is distributed.

Further, in the control device used in the image forming apparatus of the present invention, a construction for detecting the start and end of image output may be designed by combining any of the first, second and third embodiments, as desired. For example, it is possible to design the construction such that the sheet leading edge detection signal is detected as the image output start signal (first embodiment), and the sheet trailing edge detection interrupt signal (second embodiment) or the valid image output termination interrupt signal (third embodiment) is detected as the image output end signal.

Aspects of the present invention can also be realized by a computer of a system or apparatus (or devices such as a CPU or MPU) that reads out and executes a program recorded on a memory device to perform the functions of the above-described embodiments, and by a method, the steps of which are performed by a computer of a system or apparatus by, for example, reading out and executing a program recorded on a memory device to perform the functions of the above-described embodiments. For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2010-089411, filed Apr. 8, 2010, and Japanese Patent Application No. 2011-064830, filed Mar. 23, 2011, which are hereby incorporated by reference herein in their entirety.

What is claimed is:

1. A control device that controls output of a clock signal to a data processing circuit that executes data processing in synchronism with the input clock signal, comprising:
a first clock output unit configured to output a first clock signal for the data processing;
a second clock output unit configured to output a second clock signal of which frequency is lower than that of the first clock signal for the data processing;
a switching unit configured to switch the clock signal between the first clock signal for the data processing output from said first clock output unit and the second clock signal output from said second clock output unit and output the clock signal to the data processing circuit; and
a control unit configured to cause said switching unit to output the first clock signal for the data processing when the data processing is executed by the data processing circuit, and cause said switching unit to output the second clock signal when the data processing is not executed by the data processing circuit.

2. The control device according to claim 1, further comprising a sensor that is disposed on a conveying path for conveying a sheet into an image forming section and is configured to detect a leading edge and a trailing edge of the sheet, and
wherein the data processing circuit is configured as a circuit that performs the data processing for image formation by the image forming section, and
wherein said control unit comprises:
a selection unit that is configured to receive a sheet leading edge detection signal output by said sensor when said sensor detects the leading edge of the sheet being conveyed, to output an image output start signal, and is configured to receive a sheet trailing edge detection signal output by said sensor when said sensor detects the trailing edge of the sheet being conveyed, to output an image output end signal, and
a detection unit configured to receive the image output start signal from said selection unit to cause said switching unit to output the first clock signal for the data processing, and is configured to receive the image output end signal from said selection unit to cause said switching unit to output the second clock signal.

3. The control device according to claim 1, further comprising a sensor that is disposed on a conveying path for conveying a sheet into an image forming section and is configured to detect a leading edge and a trailing edge of the sheet, and
wherein the data processing circuit is configured as a circuit that performs the data processing for image formation by the image forming section, and
wherein said control unit receives a signal generated when said sensor detects the leading edge of the sheet being conveyed, to cause said switching unit to output the first clock signal for the data processing, and
said control unit receives a signal generated when said sensor detects the trailing edge of the sheet being conveyed, to cause said switching unit to output the second clock signal.

4. The control device according to claim 1, further comprising a sensor that is disposed on a conveying path for conveying a sheet into an image forming section and is configured to detect a leading edge and a trailing edge of the sheet, and
wherein the data processing circuit is configured as a circuit that performs the data processing for image formation by the image forming section, and
wherein said control unit receives a signal generated when said sensor detects the leading edge of the sheet being conveyed, to cause said switching unit to output the first clock signal for the data processing, and
said control unit receives a signal generated when output of a valid image to be formed on the sheet is terminated, to cause said switching unit to output the second clock signal.

5. The control device according to claim 1, wherein said switching unit switches the clock signal in a low-level section.
